(19) United States
(12) Patent Application Publication
(10) Pub. No.: US 2006/0068164 A1
(43) Pub. Date: Mar. 30, 2006

(54) Film carrier tape for mounting electronic devices thereon and flexible substrate

(75) Inventor: Yutaka Iguchi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUI MINING & SMELTING CO., LTD.

(21) Appl. No.: 11/235,139

(22) Filed: Sep. 27, 2005

(30) Foreign Application Priority Data
Sep. 29, 2004 (JP) 2004-285499
Sep. 16, 2005 (JP) 2005-269691

(51) Int. Cl. B32B 3/10

(52) U.S. Cl. 428/131; 428/209

(57) ABSTRACT

The invention provides a film carrier tape for mounting electronic devices thereon and a flexible substrate, which prevent generation of static electricity, thereby enhancing reliability and productivity of a semiconductor chip mounting line. The film carrier tape for mounting electronic devices thereon including a continuous insulating layer; a wiring pattern formed through patterning of a conductor layer and provided on at least a top surface of the insulating layer; a row of sprocket holes provided along each longitudinal edge of the wiring pattern; an electricity-conducting layer provided on the top surface of the insulating layer continuously in the longitudinal direction of the insulating layer; and an antistatic layer formed of an antistatic agent which is provided at least on each longitudinal edge or in an area in the vicinity of each edge of a bottom surface of the insulating layer in the longitudinal direction of the insulating layer, wherein the electricity-conducting layer or the conductor layer electrically connected with the electricity-conducting layer is electrically connected with the antistatic layer through a longitudinal side surface of the tape or through inner peripheral surfaces of the sprocket holes.

### BACKGROUND OF THE INVENTION

1. Field of the Invention

The present invention relates to a film carrier tape on which electronic devices are to be mounted, and to a flexible substrate. The film carrier tape and the flexible substrate serve as substrates on which electronic devices such as IC chips and LSI chips are mounted.

2. Description of the Related Art

Development of the electronics industry has been accompanied by sharp demand for printed wiring boards for mounting electronic devices thereon, such as IC chips (Integrated Circuits) and LSI chips (Large-Scale Integrated circuits). Manufacturers have attempted to realize small-size, lightweight, and high-function electronic equipment, which has long been desired. To this end, manufactures have recently come to employ a film carrier tape, such as a TAB tape, a T-BGA tape, or an ASIC tape. Use of film carrier tapes has become increasing important, especially for manufacturers of personal computers, cellular phones, and other electronic equipment employing a liquid crystal display (LCD) that must have high resolution and flatness, as well as a narrow screen-frame area.

Such a film carrier tape for mounting electronic devices thereon is produced by providing, for example, sprocket holes for conveying the film carrier tape, device holes, and other holes in an insulating layer made of polyimide; subsequently providing a conductor layer on a surface of the insulating layer, patterning the conductor layer while the insulating layer is conveyed with the sprocket holes, to thereby form a wiring pattern; and subsequently forming an insulating protective layer on the wiring pattern in accordance with needs.

There has arisen demand for considerably reducing the thickness of such a film carrier tape itself for mounting electronic devices thereon, in order to keep pace with a trend for downsizing of electronic devices. Thus, in recent years, a COF (chip on film) tape employing a relatively thin insulating layer has been proposed.

Before or after the step of mounting electronic devices such as semiconductor chips (ICs), the film carrier tape is unwounded from a reel or wounded, during which static electricity tends to be generated to causes problematic electrostatic breakdown of ICs.

Meanwhile, a flexible substrate (FPC) is a type of wiring substrate that differs from a film carrier tape for mounting electronic devices thereon. Japanese Patent Application Laid-Open (kokai) No. 5-259591 discloses a flexible substrate (FPC) which includes a plastic film substrate having a metal layer provided on the top surface of the substrate, and an antistatic layer provided on the bottom surface of the substrate. In the above-proposed FPC, a protective layer is provided on the antistatic layer, and therefore, the antistatic layer does not prevent generation of static electricity during the steps of winding and unwinding. In addition, even in the case of employment of a structure in which the antistatic layer is provided simply on the backside of a film substrate, generation of static electricity in such a film substrate, particularly in a thin film carrier tape for mounting electronic devices thereon, cannot be completely prevented.

### SUMMARY OF THE INVENTION

In view of the foregoing, an object of the present invention is to provide a film carrier tape for mounting electronic devices thereon, which tape prevents generation of static electricity, thereby enhancing reliability and productivity of a semiconductor chip mounting line. Another object of the invention is to provide a flexible substrate which also prevents generation of static electricity, thereby enhancing reliability and productivity of a semiconductor chip mounting line.

Accordingly, in a first mode of the present invention, there is provided a film carrier tape for mounting electronic devices thereon, comprising
a continuous insulating layer;
a wiring pattern formed through patterning of a conductor layer and provided on at least a top surface of the insulating layer;
a row of sprocket holes provided along each longitudinal edge of the wiring pattern;
an electricity-conducting layer provided on the top surface of the insulating layer continuously in the longitudinal direction of the insulating layer; and
an antistatic layer formed of an antistatic agent which is provided at least on each longitudinal edge or in an area in the vicinity of each edge of a bottom surface of the insulating layer in the longitudinal direction of the insulating layer,
wherein the electricity-conducting layer or the conductor layer electrically connected with the electricity-conducting layer is electrically connected with the antistatic layer through a longitudinal side surface of the tape or through inner peripheral surfaces of the sprocket holes.

In the film carrier tape of the first mode, the antistatic layer provided on the bottom surface and the electricity-conducting layer provided on the top surface are electrically connected with each other. Therefore, generation of static electricity during steps of uncoiling and coiling up of the film can be reliably prevented.

In a second mode of the present invention, the electricity-conducting layer may be a conductive pattern which is provided through patterning of the conductor layer and which is provided around the sprocket holes continuously in the longitudinal direction.

In the film carrier tape of the second mode of the invention, the electricity-conducting layer and the wiring pattern are formed in a single patterning step, and the electricity-conducting layer also serves as a reinforcement layer during conveyance of the tape by means of the sprocket holes.

In a third mode of the present invention, the electricity-conducting layer may be a conductive pattern which is provided through patterning of the conductor layer and which is provided intermittently along each longitudinal edge.

In the film carrier tape of the third mode of the invention, the electricity-conducting layer is a strip-form layer provided along each longitudinal edge, and can be formed simultaneously with patterning to form the wiring pattern.

In a fourth mode of the present invention, the electricity-conducting layer may be a conductive pattern which is provided through patterning of the conductor layer and which is provided continuously in a region between the wiring pattern and the row of the sprocket holes in the longitudinal direction.

In the film carrier tape of the fourth mode of the invention, the electricity-conducting layer is a strip-form layer provided continuously in a region between the wiring pattern and the row of the sprocket holes in the longitudinal direction, and can be formed simultaneously with patterning to form the wiring pattern.

In a fifth mode of the present invention, the electricity-conducting layer may be an antistatic layer for conduction which is formed of an antistatic agent and which is provided continuously along at least the longitudinal edge of the insulating layer or around the sprocket holes in the longitudinal direction.

In the film carrier tape of the fifth mode of the invention, the electricity-conducting layer is an antistatic layer for conduction which is formed of an antistatic agent, and can be readily formed in the longitudinal direction.

In a sixth mode of the present invention, the film carrier tape may further include a reinforcement layer which is provided through patterning of the conductor layer and which is provided so as to surround the row of sprocket holes in the longitudinal direction in a continuous manner or a discontinuous manner at predetermined intervals, and the reinforcement layer and the electricity-conducting layer are electrically connected at a predetermined position in the longitudinal direction.

In the film carrier tape of the sixth mode of the invention, the reinforcement layer around the sprocket holes and the electricity-conducting layer are electrically connected. Thus, generated electrostatic charge can be removed via the reinforcement layer, thereby exhibiting an antistatic effect.

In a seventh mode of the present invention, the wiring pattern and the electricity-conducting layer may be electrically connected.

In the film carrier tape of the seventh mode of the invention, the wiring pattern and the electricity-conducting layer are electrically connected. Thus, generated electrostatic charge can be removed via the wiring pattern, thereby exhibiting an antistatic effect.

In an eighth mode of the present invention, there is provided a flexible substrate comprising
a continuous insulating layer;
a wiring pattern formed through patterning of a conductor layer and provided on a top surface of the insulating layer;
an electricity-conducting layer provided on the top surface of the insulating layer continuously in the longitudinal direction of the insulating layer; and
an antistatic layer formed of an antistatic agent which is provided at least on each longitudinal edge or in an area in the vicinity of each edge of a bottom surface of the insulating layer in the longitudinal direction of the insulating layer,
wherein the electricity-conducting layer or the conductor layer electrically connected with the electricity-conducting layer is electrically connected with the antistatic layer through a longitudinal side surface.

In the flexible substrate of the eighth mode, the antistatic layer provided on the bottom surface and the electricity-conducting layer provided on the top surface are electrically connected with each other. Therefore, generation of static electricity during uncoiling, conveyance, and coiling up of the film can be reliably prevented.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1A is a schematic plan view of a film carrier tape for mounting electronic devices thereon according to one embodiment of the present invention;

FIG. 1B is a schematic cross-sectional view of the film carrier tape for mounting electronic devices thereon according to the same embodiment of the present invention;

FIG. 2 is a schematic plan view of a film carrier tape for mounting electronic devices thereon according to another embodiment of the present invention;

FIGS. 3A to 3G are cross-sectional views showing a method of producing a film carrier tape for mounting electronic devices thereon according to one embodiment of the present invention;

FIG. 4A is a schematic plan view of a film carrier tape for mounting electronic devices thereon according to another embodiment of the present invention;

FIG. 4B is a schematic cross-sectional view of the film carrier tape for mounting electronic devices thereon according to the same embodiment of the present invention;

FIG. 5A is a schematic plan view of a film carrier tape for mounting electronic devices thereon according to another embodiment of the present invention;

FIG. 5B is a schematic cross-sectional view of the film carrier tape for mounting electronic devices thereon according to the same embodiment of the present invention;

FIG. 6A is a schematic plan view of a film carrier tape for mounting electronic devices thereon according to another embodiment of the present invention; and

FIG. 6B is a schematic cross-sectional view of the film carrier tape for mounting electronic devices thereon according to the same embodiment of the present invention;

### DETAILED DESCRIPTION OF PREFERRED EMBODIMENTS

Hereafter, a COF film carrier tape, which is one embodiment of the film carrier tape for mounting electronic devices thereon of the present invention, will be described. The following embodiments of the present invention will be described taking a COF film carrier tape as an example. However, needless to say, those with ordinary skill in the art would readily understand that TAB tapes and FPCs can also be realized in an analogous manner.

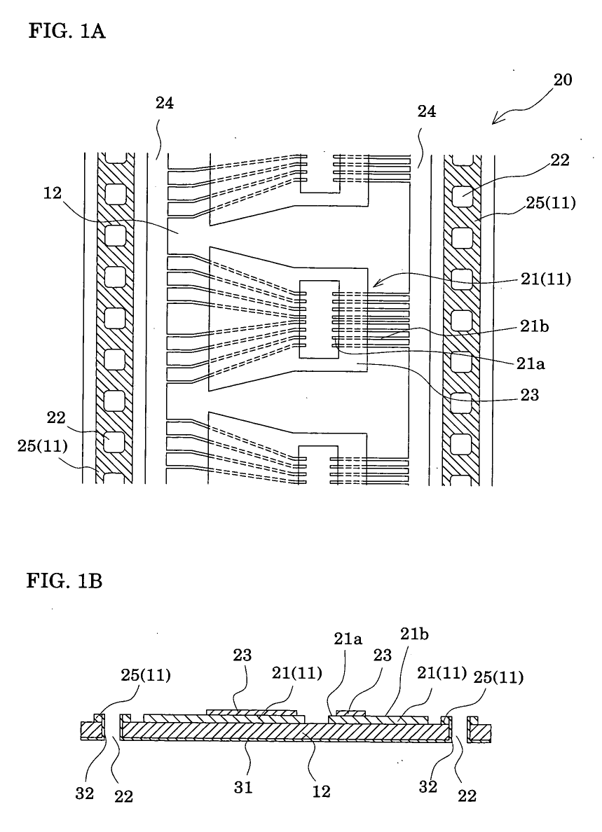

FIGS. 1A and 1B show a COF film carrier tape 20 according to one embodiment of the present invention.

As shown in FIGS. 1A and 1B, the COF film carrier tape 20 according to the present embodiment is produced from a laminate film for producing a COF, the laminate film comprising a conductor layer 11 (copper layer) and an insulating layer 12 (polyimide film). The COF film carrier tape 20 has wiring patterns 21 obtained by patterning the conductor layer 11, and a pair of transversely spaced rows of sprocket holes 22 provided along opposite longitudinal edges; this is, the two rows of sprocket holes 22 are disposed such that one row extends along each of the opposite longitudinal edges of the wiring pattern 21. Each wiring pattern 21 has, on a surface thereof, an insulating protective layer 23 which is formed by applying a solder resist coating solution through screen printing or attaching film thereto. Inner leads 21a, which are portions of the wiring pattern 21, are provided in a center of the wiring pattern 21 such that each inner lead 21a extends to a portion on which a semiconductor chip is mounted. Outer leads 21b, which are portions of the wiring pattern 21 and serve as external connector terminals, are provided such that each outer lead 21b extends to a portion outside the insulating protective layer 23 and opposite the inner leads 21a.

A plurality of wiring patterns 21 are provided on a surface of the insulating layer 12 in the longitudinal direction thereof. These wiring patterns 21 are connected with one another by the mediation of conducting bars 24 for plating, each provided between a row of sprocket holes 22 and a row of wiring patterns. The wiring patterns may be provided on both sides of the insulating layer 12 (such COF film carrier tape is called “2-metal COF film carrier tape”).

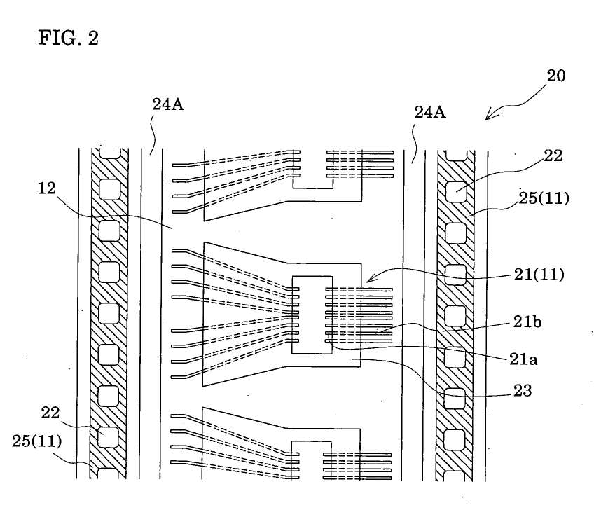

When plating is performed through electroless plating (e.g., Sn plating), the above conducting bars 24 for plating are not needed. However, needless to say, presence of these conducting bars does not impede the function of the film carrier tape. In the case of electroless plating, as shown in FIG. 2, conducting bars may be provided in the form of patterns 24A, which are not electrically connected with the wiring patterns 21. Notably, conducting bars 24 for plating or patterns 24A serve as ground, and as dams for preventing flow of an antistatic agent to wiring patterns 21, as mentioned below.

In the present embodiment, a reinforcement layer 25 formed from the conductor layer 11 is provided around the sprocket holes 22 continuously in the longitudinal direction. The reinforcement layer serves as an electricity-conducting layer. On the backside of the insulating layer 12, an antistatic layer 31 is provided. An interlayer connecting layer (connecting surface) 32 is provided on inner peripheral surfaces of the sprocket holes 22, the connecting layer 32 connecting the antistatic layer 31 with the reinforcement layer 25 serving as an electricity-conducting layer.

Although the conductor layer 11 can be formed from a metal other than copper; e.g., aluminum, gold, or silver, a copper layer is generally employed. No particular limitation is imposed on the type of copper layer, and any type of copper layers, such as a copper layer formed through vapor deposition or plating, electrodeposited copper foil, or rolled copper foil, can be used. Generally, the conductor layer 11 has a thickness of 1 to 70 μm, preferably 5 to 35 μm.

The insulating layer 12 may be formed from, other than polyimide, a polymeric material such as polyester, polyamide, polyether-sulfone, or liquid crystalline polymer. Of these, an aromatic polyimide (all repeating units being aromatic) prepared by polymerizing pyromellitic dianhydride and 4,4′-diaminodiphenyl ether (e.g., Kapton EN, product of Du Pont-Toray Co., Ltd.) and biphenyltetracarboxylic dianhydride-p-phenylenediamine (PPD) polymer (e.g., Upilex S, product of Ube Industries, Ltd.) are preferred. The thickness of the insulating layer 12 generally falls within a range of 12.5 to 125 μm, preferably 12.5 to 75 μm, more preferably 12.5 to 50 μm.

The laminate film for producing a COF is produced by, for example, applying to a conductor layer 11 (copper foil) a polyimide precursor resin composition containing a polyimide precursor and varnish, to thereby form a coating layer; removing the solvent by drying; winding the coating layer; and heating the wound coating layer in an oxygen-purged curing furnace for imidization, to thereby form the insulating layer 12. However, no particular limitation is imposed on the method for producing the laminate film. Examples of such laminate film include a laminate film prepared by sputtering a bond-improving layer (e.g., Ni alloy) on the insulating film (e.g., polyimide film) and plating copper on the bond-improving layer; a casting-type laminate film; and a laminate film prepared through hot-press-adhesion of an insulating film onto copper foil by the mediation of a thermoplastic or thermosetting resin. In the present invention, any of these laminate films may be employed.

The antistatic layer 31 and the interlayer connecting layer 32 are formed from an antistatic agent.

Any of known antistatic agents may be employed as the antistatic agent of the present invention. For example, organic antistatic agents such as a variety of known surfactants may be used. Such an organic antistatic agent itself or a mixture of the agent with a binder formed of a UV-curable resin and another resin is applied, to thereby form the antistatic layer 31 and the interlayer connecting layer 32.

The antistatic layer may be formed from a silicone compound also serving as a release agent; i.e., a compound having a siloxane bond (Si—O—Si). A layer comprising a silicone compound is preferred, since the layer can be formed in a relatively simple manner and does not tend to adversely affect adhesion of mold resin of semiconductor device even when the releasing layer is transferred to a mount side of the produced printed wiring board.

Examples of the antistatic agent containing a silicone compound; i.e., the antistatic agent for forming a layer composed of a siloxane-bond-containing compound, include those agents containing at least one species selected from among silicone-based siloxane compounds such as disiloxane and trisiloxane. Preferably, the antistatic agent comprises a compound which transforms into a silicone compound through application and reaction of the antistatic agent. Examples of such compounds include silane compounds such as monosilane, disilane, and trisilane; and silica sol compounds. Examples of more preferred antistatic agents include antistatic agents each containing an alkoxysilane compound, which is a type of silane compound, or a silazane compound such as hexamethyldisilazane or perhydropolysilazane, which belongs to silane compounds having an Si—NH—Si structure serving as a precursor for forming a siloxane bond. These compounds form a compound having a siloxane bond through application thereof or reaction with moisture or a similar substance contained in air after the application. However, unreacted Si—NH—Si may also be present in compounds, for example, silazanes.

Although the above silicone-based antistatic agents generally contain an organic solvent, similar antistatic agents of aqueous solution type or emulsion form may also be employed.

Specific examples of the release agents include silcone oil predominantly containing dimethylsiloxane; silicone resin SR 2411 (trade name: product of Dow Corning Toray Silicone Co., Ltd., containing methyltri(methyl ethyl ketoxime)silane, toluene, a ligroin); silicone resin SEPA-COAT (trade name: product of Shin-Etsu Chemical Co., Ltd., containing silazane, synthetic isoparaffin, and ethyl acetate); and COLCOAT SP-2014S (trade name: product of Colcoat Co., Ltd., containing a silane compound). Examples of release agents containing silica sol include COLCOAT P (trade names: products of Colcoat Co., Ltd.). Silica particles contained in silica sol have a particle size of, for example, 0.005 to 0.008 μm (50 to 80 Å).

When the antistatic layer is formed from such a silicone compound, the antistatic layer also serves as a releasing layer which has excellent releasability for preventing adhesion of the laminate film to a heating tool during mounting of semiconductor chips. Provision of an antistatic layer 31 and an interlayer connecting layer 32 each formed of a silicone-based release agent containing a silazane compound is particularly preferred, since the release agent does not induce melt adhesion by heating. Examples of such antistatic agents containing a silazane compound include silicone resin SEPA-COAT (trade name, product of Shin-Etsu Chemical Co., Ltd., containing silazane, synthetic isoparaffin, and ethyl acetate).

In consideration of the antistatic effect, the antistatic layer 31 may be provided only on the opposite longitudinal edges of the tape other than the longitudinal center area of the tape. Alternatively, the opposite longitudinal edges of the tape may be coated with an organic antistatic agent having no releasability, and the center area, which is the backside corresponding to the mounting area, may be coated with a silicone-based antistatic agent having releasability.

No particular limitation is imposed on the method for forming the antistatic layer 31 and the interlayer connecting layer 32, and any known method can be employed. For example, an antistatic agent or a liquid thereof may be applied to a substrate through spraying, dipping, or roller-coating. Alternatively, an antistatic layer provided on a film substrate may be transferred. In the case in which the antistatic layer 31 and the interlayer connecting layer 32 are formed on the opposite longitudinal edges of a film carrier tape through roller coating, a roller for coating may be inclined by 0.1° to 90° during coating operation. In any case, bonding between the insulating layer and the antistatic layer may be enhanced through, for example, heat treatment in order to prevent peeling of the antistatic layer from the insulating layer.

The antistatic layer 31 and the interlayer connecting layer 32 may be provided in one single step, or the interlayer connecting layer 32 may be separately provided.

No particular limitation is imposed on the timing of provision of the antistatic layer 31 and the interlayer connecting layer 32, so long as the layer and the connecting layer are is provided prior to mounting of semiconductor elements. Specifically, the layer and the connecting layer may be provided after provision of the conductor layer; provided in advance on an insulating layer which has not been provided with a conductor layer; or provided simultaneously with provision of the conductor layer. Needless to say, the layer and the connecting layer are not necessarily provided prior to patterning of the conductor layer, but may be provided after patterning of the conductor layer.

The transfer method is preferably employed in the cases in which, for example, the antistatic layer and the interlayer connecting layer are provided after provision of the conductor layer or in advance on an insulating layer which has not been provided with a conductor layer. When the layer and the connecting layer are provided after patterning of the conductor layer, the application method is preferably employed. Needless to say, the timing of formation of the layer and the connecting layer is not limited, and the layer and the connecting layer may be provided at an initial stage before patterning of the conductor layer through application or may be provided after patterning of the conductor layer through transfer.

In one embodiment of the production method of the present invention, the antistatic layer 31 and the interlayer connecting layer 32 are provided after completion of photolithography and before mounting of semiconductor elements. The reason for choosing the above timing is that the antistatic layer 31 or a similar layer is possibly dissolved by a photoresist remover or a similar material. Therefore, the antistatic layer and the interlayer connecting layer are preferably provided after the processes of etching of the conductor layer and removal of a resist mask for forming a wiring pattern. Specifically, the antistatic layer and the interlayer connecting layer are preferably provided, for example, after the processes of removal of a resist mask and formation of a tin plating layer. Alternatively, the antistatic layer and the interlayer connecting layer are preferable provided after a series of processes of removal of the resist mask, provision of an insulating protective layer, and plating of a lead electrode. Such an antistatic layer and an interlayer connecting layer may be formed by applying a solution containing a release agent and bringing the applied solution to dryness. However, in order to enhance bonding strength between the insulating layer and the antistatic layer 31 or the interlayer connecting layer 32, the applied solution is preferably heated. The conditions under which the heating is performed are, for example, at 50 to 200° C. for one minute to 120 minutes, preferably 100 to 200° C. for 30 minutes to 120 minutes.

According to another embodiment of the method of the present invention, a releasing layer provided on a film substrate may be transferred to the surface of the insulating layer opposite the conductor layer; i.e., the surface opposite the semiconductor-chip (IC chip)-mounting side, to thereby form the antistatic layer 31. Exemplary conditions under which the transfer is performed are, but are not limited to, a heating temperature of 15 to 200° C., a load for rolling or pressing of 5 to 50 kg/cm², and a treatment time of 0.1 seconds to two hours. After completion of transfer, bonding between the insulating layer 12 and the antistatic layer 31 may be enhanced through, for example, heat treatment in order to prevent peeling of the antistatic layer from the insulating layer. Exemplary conditions under which the heating is performed are, but are not limited to, at 50 to 200° C. for one minute to 120 minutes, preferably 100 to 200° C. for 30 minutes to 120 minutes.

According to the above transfer method, no particular limitation is imposed on the timing of provision of the antistatic layer 31, so long as the layer is provided prior to mounting of semiconductor elements. Specifically, the antistatic layer may be provided in advance on an insulating layer which has not been provided with a conductor layer; or provided simultaneously with provision of the conductor layer. Needless to say, the antistatic layer is, not necessarily provided prior to patterning of the conductor layer, but may be provided after patterning of the conductor layer.

The transfer method is preferably employed in the cases in which, for example, the antistatic layer 31 is provided in advance on an insulating layer which has not been provided with a conductor layer. In the case in which the antistatic layer is provided through the transfer method at an initial stage of production of the COF flexible printed wiring board, the following procedure may be employed. Specifically, the film substrate is not peeled from the antistatic layer, so as to serve as a reinforcing film, and the film substrate is removed at a final production step.

Particularly when the transfer method is employed, the interlayer connecting layer 32 must be provided in another step. In this case, the interlayer connecting layer 32 may be formed through brush coating or spraying, while a sealing member is laminated on the top surface of the film carrier tape for closing the sprocket holes 22, so as to prevent flow of an antistatic agent to the top surface. Alternatively, a coating member having a pattern similar to that of the sprocket holes may also be employed. In addition, in order to prevent flow of an antistatic agent to the wiring patterns 21, a dam structure may be provided. In the present embodiment, the aforementioned conducting bars 24 for plating serve as dams. Needless to say, a dam layer may be provided between each conducting bar 24 for plating and the reinforcement layer 25.

In the present embodiment, the antistatic layer 31 and the interlayer connecting layer 32 are formed from an antistatic agent containing silica sol. The antistatic layer 31 has a thickness of, for example, 0.001 to 1 μm.

The COF film carrier tape of the present invention is employed in, for example, a step of mounting electronic devices such as semiconductor chips and passive elements, while the tape is unwounded from a reel and conveyed. Generation of static electricity during the mounting step can be prevented, whereby electrostatic breakdown and similar failures of electronic devices can be prevented.

In use of the COF flexible printed wiring board of the present invention, a semiconductor chip is mounted thereon. No particular limitation is imposed on the mounting method. For example, semiconductor chips are mounted by positioning and disposing the COF flexible printed wiring board on semiconductor chips which are placed on a chip stage, and pressing a heating tool against the COF flexible printed wiring board. In this case, the heating tool is heated to at least 200° C., or in some cases, 350° C. or higher. However, since the COF flexible printed wiring board has an antistatic layer having releasability formed on the insulating layer, it take effect melt adhesion between the heating tool and the insulating layer can be prevented also.

Since the insulating layer 12 and the antistatic layer 31 has an optical transmittance of 50% or higher, the image of the wiring patterns 21 (e.g., inner leads) can be recognized from the side of the antistatic layer 31 by means of a CCD or a similar device.

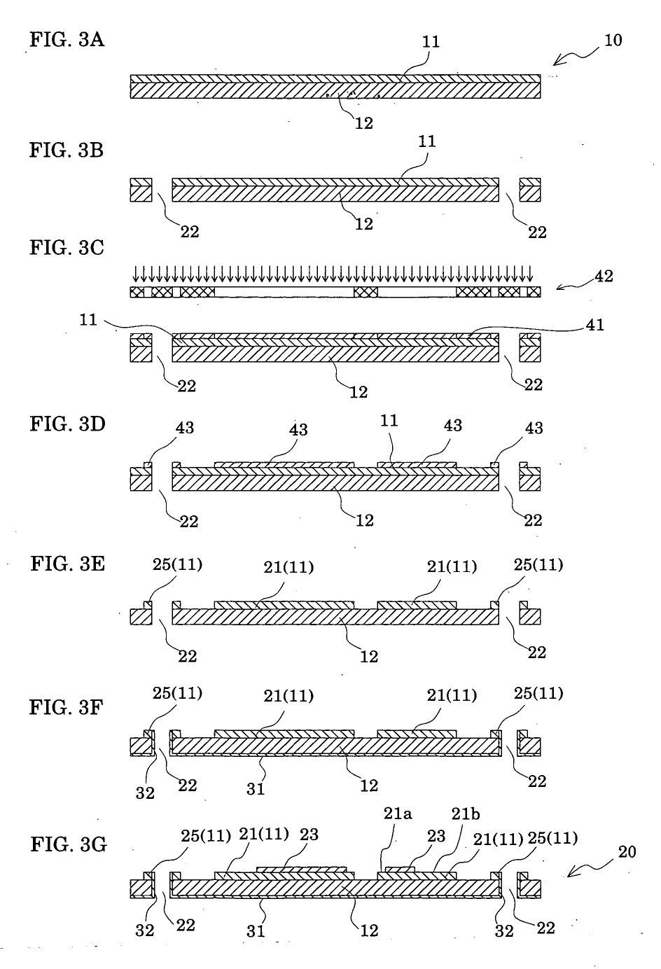

Next, one exemplary method of producing the aforementioned COF film carrier tape will be described with reference to FIGS. 3A to 3G.

As shown in FIG. 3A, a laminate film 10 for producing a COF is provided. As shown in FIG. 3B, sprocket holes 22 are formed, by punching or a similar method, through a conductor layer 11 and an insulating layer 12. These sprocket holes 22 may be formed from the front side or the backside of the insulating layer 12. Then, as shown in FIG. 3C, a photoresist coating layer 41 is formed on a region of the conductor layer 11 for providing a wiring pattern 21, through a routine photolithographic method involving application of, for example, a negative-type photoresist coating solution. Needless to say, a positive-type photoresist may also be employed. After the insulating layer 12 is positioned by inserting positioning pins in the sprocket hole 22, the photoresist coating layer 41 is exposed via a photomask 42 and developed for patterning thereof, thereby forming a resist pattern 43 for providing a wiring pattern as shown in FIG. 3D. Subsequently, the conductor layer 11 is removed by dissolving, with an etchant, through the resist pattern 43 serving as a mask pattern, and the resist pattern 43 is removed by dissolving with an alkaline solution or a similar material, thereby forming a wiring pattern 21 as shown in FIG. 3E.

The entirety of the thus-formed wiring pattern 21 is plated (e.g., plated with tin) in accordance with needs. Subsequently, as shown in FIG. 3F, an antistatic layer 31 and an interlayer connecting layer 32 are formed, through the application method, on the bottom surface of the insulating layer 12 and on inner peripheral surfaces of the sprocket holes 22. Although the applied antistatic layer 31 and interlayer connecting layer 32 may be simply dried, heating of the layer and the connecting layer is preferred, for enhancing bonding to the insulating layer and a releasing effect; i.e., for preventing melt adhesion of the insulating layer to a heating tool during mounting of IC chips. Exemplary conditions under which the heating is performed are 50 to 200° C. for one minute to 120 minutes, preferably 100 to 200° C. for 30 minutes to 120 minutes, but the heating conditions are not limited thereto. The heating process may be preformed simultaneously with curing solder resist. Subsequently, an insulating protective layer 23 is formed through, for example, screen printing, as shown in FIG. 3G. An outer lead and an inner lead, which are not covered with the insulating protective layer 23, are plated with a metal in accordance with needs. No particular limitation is imposed on the material of the metal plating layer, and tin plating, tin alloy plating, nickel plating, gold plating, gold alloy plating, or Pb-free solder plating such as Sn—Bi alloy may appropriately be employed in accordance with the purpose of use. Examples of the plating method include two-step plating in which a metal (e.g., Sn) plating layer is provided before and after formation of the insulating protective layer 23; pre-plating in which a metal plating layer is provided before formation of the insulating protective layer 23; and post-plating in which a metal (Sn, Au, or Ni) plating layer is provided after formation of the insulating protective layer 23.

In the embodiment described above, the antistatic layer 31 and the interlayer connecting layer 32 are formed after removal of the resist pattern 43 with an alkali solution or a similar material and before provision of the insulating protective layer 23. Alternatively, the antistatic layer 31 and the interlayer connecting layer 32 may be formed in the final production step after provision of the insulating protective resist layer 23. For example, the antistatic layer 31 and the interlayer connecting layer 32 may be formed after formation of the second plating layer provided in the second step of the two-step plating process. When the antistatic layer 31 and the interlayer connecting layer 32 are formed through the latter method, exposure of the antistatic layer 31 and the interlayer connecting layer 32 to an etchant, a photoresist remover, etc. is prevented, thereby attaining a high antistatic effect and a high releasing effect, which is advantageous.

As described above, the antistatic layer of the present invention is preferably formed after the photolithography step for forming wiring patterns 21 and before bonding with electronic parts such as semiconductor chips. The reason for the timing is that the antistatic layer is possibly dissolved in a photoresist layer removal step. Therefore, the antistatic layer is preferably formed after completion of the photolithography step or after plating, more preferably after formation of the insulating protective layer 23 or a similar step. Needless to say, the antistatic layer may also be formed before the photolithography step.

In the COF film carrier tape of the present embodiment, a reinforcement layer is provided around each row of the sprocket holes 22 in order to reinforce the sprocket holes 22 during conveyance of the film carrier tape for positioning and mounting of semiconductor chips thereon. The reinforcement layer 25 serves as an electricity-conducting layer. Through provision of the reinforcement layer, breakage or similar damage of the film carrier tape during conveyance as well as generation of static electricity due to sprocket-related friction can be prevented.

### Other Embodiments

Needless to say, the film carrier tape for mounting electronic devices thereon according to the present invention is not limited to the aforementioned embodiment of the present invention.

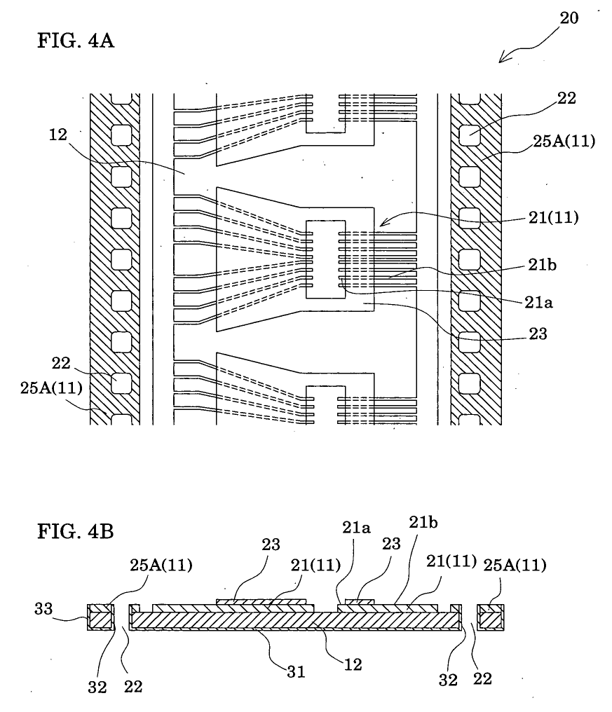

For example, as shown in FIGS. 4A and 4B, the electricity-conducting layer may be a reinforcement layer 25A which surrounds the sprocket holes and extends to each longitudinal edge of the film carrier tape. In this case, an interlayer connecting layer (connecting surface) 33 may be provided on each side surface of the film carrier tape. At least one of the interlayer connecting layers 32 and 33 is provided.

Alternatively, the electricity-conducting layer may be provided on each longitudinal edge of the insulating layer 12 such that the conducting layer does not surround the sprocket holes.

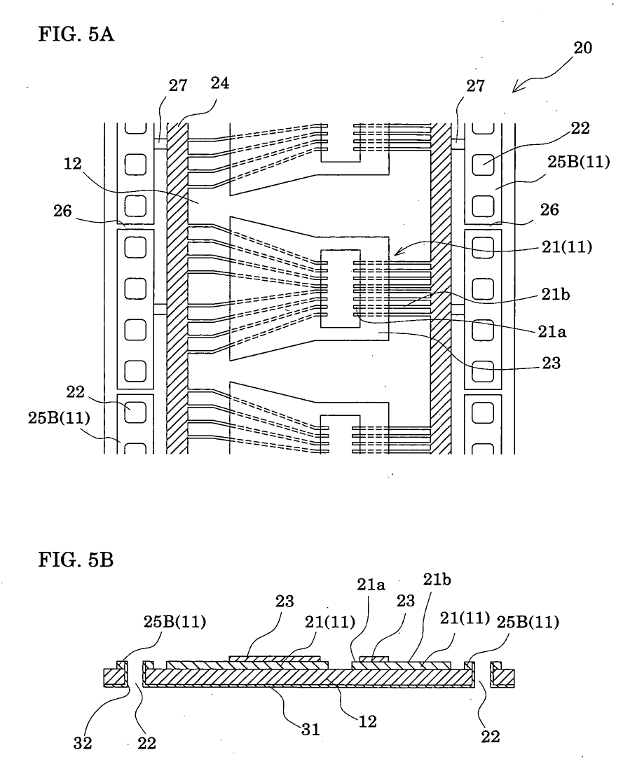

The reinforcement layer serving as an electricity-conducting layer in the aforementioned embodiment is not necessarily provided continuously in the longitudinal direction of the insulating layer. For example, as shown in FIGS. 5A and 5B, the reinforcement layer may be a conducting pattern; i.e., a reinforcement layer 25B, which is provided in a discontinuous manner in the longitudinal direction of the insulating layer 12 by provision of slits 26 in the insulating layer at intervals of three to eight sprocket holes 22. In this case, since the reinforcement layer 25B does not serve as an electricity-conducting layer, an additional electricity-conducting layer must be provided. The reinforcement layer 25B is continuous in the longitudinal direction of the insulating layer 12 corresponding to each group containing three to eight sprocket holes 22, and is intermittently provided every group of sprocket holes 22 by the mediation of the slits 26. In the present embodiment, the reinforcement layer 25B is discontinuously provided at intervals of four sprocket holes 22. Such a reinforcement layer 25B has a length in the longitudinal direction of 10 to 40 mm, corresponding to three to eight sprocket holes 22, preferably 10 to 30 mm, corresponding to three to six sprocket holes 22. In the present embodiment, the reinforcement layer 25B has a length in the longitudinal direction of 19 mm, corresponding to four sprocket holes 22. Standards of EIAJ (Electronics Industries Association of Japan) stipulate that the standard interval between the sprocket holes 22 is 4.75±0.05 mm.

According to the present embodiment, the reinforcement layer 25B is provided in a discontinuous manner in the longitudinal direction of the insulating layer 12 by provision of slits 26 on the insulating layer 12 at intervals of four sprocket holes 22. Therefore, stress produced between the reinforcement layer 25B and the insulating layer 12 is appropriately released by the provided slits 26, thereby preventing wavy deformation of the final product; i.e., the film carrier tape 20, along the opposite longitudinal edges thereof. In addition, the rigidity of the entirety of the film carrier tape is not excessively high. Therefore, even though the tape conveying route is bent, the tape itself can be conveyed in accordance with the bent conveying route, thereby attaining satisfactory tape conveyance. Needless to say, each sprocket hole 22 may be separately provided with the reinforcement layer 25B.

In the present embodiment, the reinforcement layer 25B is discontinuous in the longitudinal direction of the insulating layer. Thus, the reinforcement layer 25B is not continuously provided in the longitudinal direction and, therefore, is insufficient to serve as an electricity-conducting layer. Each reinforcement layer 25B is connected with a conducting bar 24 for plating via a connecting pattern 27. As a result, the connecting bar 24 for plating is connected with the antistatic layer 31 via the connecting pattern 27 and the interlayer connecting layer 32, thereby virtually serving as an electricity-conducting layer.

Needless to say, in the aforementioned embodiment, the reinforcement layer 25 or 25A serving as an electricity-conducting layer continuously provided in the longitudinal direction may be connected with the conducting bar 24 for plating, whereby electric charge accumulated in the wiring patterns 21 is effectively removed.

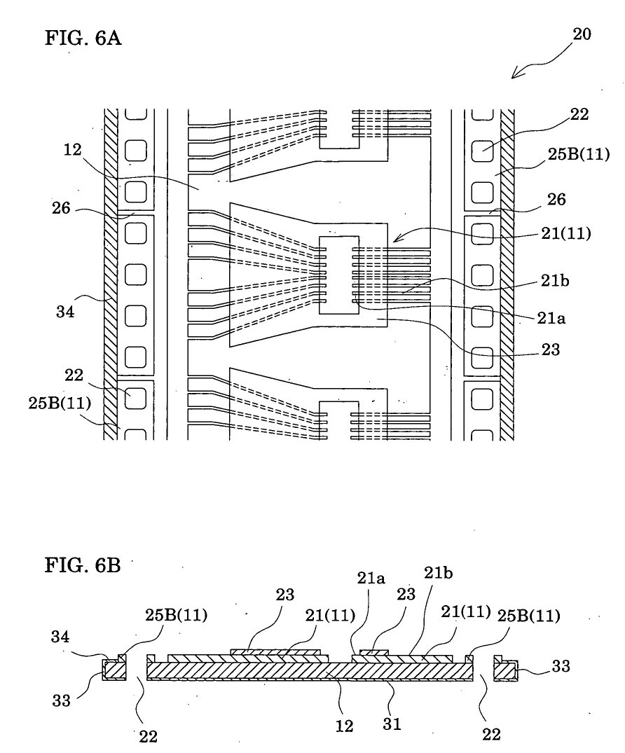

When a reinforcement layer 25B is provided discontinuously in the longitudinal direction, as shown in FIGS. 6A and 6B, an antistatic layer 34 may be provided so as to contact with the reinforcement layer 25B provided on the top surface of the insulating layer 12, thereby serving as an electricity-conducting layer. Needless to say, the antistatic layer 34 may be provided on the surface of the reinforcement layer 25B.

In this case, the antistatic layer 31 provided on the bottom surface of the insulating layer is connected with the antistatic layer 34 provided on the top surface of the insulating layer, via the interlayer connecting layer 33, and is further connected with the reinforcement layer 25B. Therefore, generation of static electricity of the film carrier tape during uncoiling and coiling of the tape can be prevented. Note that the manner in which the antistatic layer 34 serves as an electricity-conducting layer is not limited to the aforementioned embodiment.

The aforementioned embodiment has been described by taking as an example a film carrier tape 20 having one row of carrier patterns including the wiring pattern 21 and the sprocket holes 22. However, the present invention is not limited to this embodiment, and a film carrier tape may have a plurality of rows of carrier patterns.

Furthermore, the aforementioned embodiment has been described while taking a COF film carrier tape as an example. However, the film carrier tape of the present invention may assume the form of another film carrier tape for mounting thereon electronic devices of a type such as TAB, CSP, BGA, μ-BGA, FC, or QFP, and no particular limitation is imposed on the constitution of the film carrier tape.

### EXAMPLES

### Example 1

A COF film carrier tape having a structure as shown in FIGS. 4A and 4B was produced. An insulating layer 12 was formed from an aromatic polyimide (all repeating units being aromatic) prepared by polymerizing pyromellitic dianhydride and 4,4′-diaminodiphenyl ether (e.g., Kapton EN, product of Du Pont-Toray Co., Ltd.). An antistatic agent containing silica sol, COLCOAT P (trade names: product of Colcoat Co., Ltd.) was applied to the bottom surface of the insulating layer by use of a roller having a width greater than that of the COF film carrier tape, to thereby form an antistatic layer 31 and interlayer connecting layers 32 and 33. The interlayer connecting layers 32 and 33 were identified on the basis of Si intensity as determined through wavelength dispersive X-ray fluorescence analysis.

### Example 2

The procedure of Example 1 was repeated, except that a roller having a width slightly smaller than that of the COF film carrier tape was employed, to thereby form an antistatic layer 31 and an interlayer connecting layer 32 as shown in FIG. 5.

### Comparative Example 1

The procedure of Example 1 was repeated, except that an antistatic layer 31 was provided, but no interlayer connecting layer 32 or 33 was provided.

### Comparative Example 2

The procedure of Example 1 was repeated, except that no antistatic layer 31 and no interlayer connecting layer 32 or 33 was provided.

### Test Example

Each of the COF film carrier tapes produced in Examples 1 and 2 and Comparative Examples 1 and 2 was unwounded and wounded, and while conveying, IC chips were mounted on the tape. Amount of charge (kV/inch) retained in the tape and the number of electrostatically broken IC chips were measured. Table 1 shows the results. The amount of charge was determined by means of an apparatus (Hand E Stat, product of SIMCO).

TABLE 1

| | Amount of charge | Electrostatic breakdown |
|---|---|---|
| | (kV/inch) | IC (failure/total) |
| Example 1 | 0.01 | 0.005% |
| Example 2 | 0.01 | 0.005% |
| Comp. Ex. 1 | 0.8 | 1% |
| Comp. Ex. 2 | 1.5 | 5% |

As is clear from Table 1, the COF film carrier tapes of Examples 1 and 2, in which the antistatic layer is connected with the reinforcement layer 25A serving as an electricity-conducting layer, provide remarkably few IC chips that are electrostatically broken, as compared with the COF film carrier tape of Comparative Example 1, in which the antistatic layer is not connected with the reinforcement layer.

What is claimed is:

1. A film carrier tape for mounting electronic devices thereon comprising
a continuous insulating layer;
a wiring pattern formed through patterning of a conductor layer and provided on at least a top surface of the insulating layer;
a row of sprocket holes provided along each longitudinal edge of the wiring pattern;
an electricity-conducting layer provided on the top surface of the insulating layer continuously in the longitudinal direction of the insulating layer; and
an antistatic layer formed of an antistatic agent which is provided at least on each longitudinal edge or in an area in the vicinity of each edge of a bottom surface of the insulating layer in the longitudinal direction of the insulating layer,
wherein the electricity-conducting layer or the conductor layer electrically connected with the electricity-conducting layer is electrically connected with the antistatic layer through a longitudinal side surface of the tape or through inner peripheral surfaces of the sprocket holes.

2. A film carrier tape for mounting electronic devices thereon according to claim 1, wherein the electricity-conducting layer is a conductive pattern which is provided through patterning of the conductor layer and which is provided around the sprocket holes continuously in the longitudinal direction.

3. A film carrier tape for mounting electronic devices thereon according to claim 1, wherein the electricity-conducting layer is a conductive pattern which is provided through patterning of the conductor layer and which is provided intermittently along each longitudinal edge.

4. A film carrier tape for mounting electronic devices thereon according to claim 1, wherein the electricity-conducting layer is a conductive pattern which is provided at least through patterning of the conductor layer and which is provided continuously in a region between the wiring pattern and the row of the sprocket holes in the longitudinal direction.

5. A film carrier tape for mounting electronic devices thereon according to claim 1, wherein the electricity-conducting layer is an antistatic layer for conduction which is formed of an antistatic agent and which is provided continuously along at least the longitudinal edge of the insulating layer or around the sprocket holes in the longitudinal direction.

6. A film carrier tape for mounting electronic devices thereon according to claim 1, wherein the film carrier tape further includes a reinforcement layer which is provided through patterning of the conductor layer and which is provided so as to surround the row of sprocket holes in the longitudinal direction in a continuous manner or a discontinuous manner at predetermined intervals, and the reinforcement layer and the electricity-conducting layer are electrically connected at a predetermined position in the longitudinal direction.

7. A film carrier tape for mounting electronic devices thereon according to claim 1, wherein the wiring pattern and the electricity-conducting layer are electrically connected.

8. A flexible substrate comprising
a continuous insulating layer;
a wiring pattern formed through patterning of a conductor layer and provided on a top surface of the insulating layer;
an electricity-conducting layer provided on the top surface of the insulating layer continuously in the longitudinal direction of the insulating layer; and
an antistatic layer formed of an antistatic agent which is provided at least on each longitudinal edge or in an area in the vicinity of each edge of a bottom surface of the insulating layer in the longitudinal direction of the insulating layer,
wherein the electricity-conducting layer or the conductor layer electrically connected with the electricity-conducting layer is electrically connected with the antistatic layer through a longitudinal side surface.
